(19) United States
(12) Patent Application Publication
(10) Pub. No.: US 2003/0157274 A1
(43) Pub. Date: Aug. 21, 2003

(54) Manufactured article made of ceramic, natural or artificial stone, for finishing buildings, claddings, furnishings or the like

(75) Inventor: Giancarlo Guerri, Viano (IT)

Correspondence Address: MODIANO & ASSOCIATI, Via Meravigli, 16, Milano, 20123, IT

(73) Assignee: SISTEMA S.R.L.

(21) Appl. No.: 10/367,902

(22) Filed: Feb. 19, 2003

(30) Foreign Application Priority Data
Feb. 19, 2002 (IT) MO2002A000040

(51) Int. Cl. B44F 9/04

(52) U.S. Cl. 428/15

(57) ABSTRACT

A manufactured article made of ceramic, natural or artificial stone, for finishing buildings, claddings, furnishings or the like, comprising at least two substantially flat elements made of ceramic, natural or artificial stone, which are mutually assembled and in which the surfaces that are in mutual contact are different from the respective laying surfaces, the elements being mutually coupled so as to form a monolithic body by fixing elements that are arranged at least proximate to the region where they are joined, the body having a profiled front surface forming the exposed surface of the manufactured article and a rear surface forming the surface for coupling the manufactured article to portions or surfaces of buildings, claddings, furnishings or the like to be finished.

### BACKGROUND OF THE INVENTION

The present invention relates to a manufactured article made of ceramic, natural or artificial stone, for finishing buildings, claddings, furnishings or the like.

Profiles are known which are used in the building and furnishing fields to finish, in particular, the claddings of protruding edges and surfaces, such as, for example, the edges that join the riser and the tread of steps.

There are profiles, constituted by elongated bodies provided with a contoured front surface and with rear means for anchoring to the surface to be finished, which are obtained by pressing or drawing ceramic material and are optionally glazed and decorated.

However, these known profiles have some drawbacks, including the fact that often they are not made of the same materials and/or do not have the same shade of color as the materials that constitute the surface and/or the cladding of the surface to be finished; accordingly, they do not allow to provide consistent and uniform finishes.

Manufactured articles for finishing, particularly for steps or the like, are also known which are substantially constituted by a tile to the laying surface of which a pack is coupled so as to protrude: the pack is constituted by a plurality of tile strips that are mutually superimposed and bonded by adhesive, and is arranged proximate to one side of the tile and aligned with it so as to constitute an edge; a contoured finishing fascia can be bonded by adhesive to the end of the pack.

However, these manufactured articles have drawbacks, including the fact that they require the execution of a plurality of additional operations for polishing the surfaces of the strips of tiles meant to be bonded together by adhesive; the polished strips often have uneven thicknesses that hinder their coupling.

Another drawback of known manufactured articles is that without a covering fascia they require the use of particular pigmented adhesives to give them a continuous and monolithic appearance; however, such adhesives rarely have the same shade of color as the tiles used, and remain visible and unsightly.

Another disadvantage of known manufactured articles is that they are heavy and bulky.

### SUMMARY OF THE INVENTION

The aim of the present invention is to eliminate the above-mentioned drawbacks of known profiles and manufactured articles, by providing a manufactured article made of ceramic, natural or artificial stone, for finishing buildings, claddings, furnishings or the like that is simple to manufacture, does not require the execution of additional polishing operations and does not require the use of particular and/or pigmented adhesives.

Within this aim, an object of the present invention is to provide a manufactured article that can have the same nature and color shade as the cladding or furnishing to be finished.

Another object of the present invention is to provide a manufactured article that is versatile and suitable for various finishing uses in the field of buildings, claddings and furnishing in general.

Another object of the present invention is to provide a manufactured article that is simple, relatively easy to provide in practice, safe in use, effective in operation, and has a relatively low cost.

This aim and these and other objects that will become better apparent hereinafter are achieved by the present manufactured article made of ceramic, natural or artificial stone, for finishing buildings, claddings, furnishings or the like, characterized in that it comprises at least two substantially flat elements made of ceramic, natural or artificial stone, which are mutually assembled and in which the surfaces that are in mutual contact are different from the respective laying surfaces, said elements being mutually coupled so as to form a monolithic body by fixing means that are arranged at least proximate to the region where they are joined, said body having a profiled front surface that is suitable to form the exposed surface of said manufactured article and a rear surface that is suitable to form the surface for the coupling of said manufactured article to portions or surfaces of buildings, claddings, furnishings or the like to be finished.

### BRIEF DESCRIPTION OF THE DRAWINGS

Further characteristics and advantages of the present invention will become better apparent from the following detailed description of a preferred but not exclusive embodiment of a manufactured article made of ceramic, natural or artificial stone, for finishing buildings, claddings, furnishings or the like, illustrated only by way of non-limitative example in the accompanying drawings, wherein:

FIG. 1 is a schematic view illustrating the step for cutting a tile to obtain flat elements for forming the manufactured article according to the invention;

FIG. 2 is a schematic view of the cut elements of FIG. 1;

FIG. 3 is a schematic view illustrating the step of the assembly of the elements of FIG. 2;

FIG. 4 is a schematic view of the elements of FIG. 3, in the assembled condition;

FIG. 5 is a schematic view illustrating the step for fixing the elements of FIG. 4 in a monolithic body;

FIG. 6 is a schematic view illustrating the step of profiling the body of FIG. 5;

FIG. 7 is a schematic axonometric view of a first embodiment of the manufactured article according to the invention;

FIG. 8 is a schematic view illustrating the step of profiling a body constituted by two elements in order to obtain a second embodiment of the manufactured article according to the invention;

FIG. 9 is a schematic axonometric view of a portion of the manufactured article according to the invention in the second embodiment;

FIG. 10 is a schematic view illustrating the step of profiling a body constituted by two elements in order to obtain a third embodiment of the manufactured article according to the invention;

FIG. 11 is a schematic axonometric view of a portion of the manufactured article according to the invention in its third embodiment;

FIG. 12 is a schematic sectional view of a manufactured article illustrating the step of fixing three assembled elements in order to obtain the article in a fourth embodiment thereof, according to the invention;

FIG. 13 is a schematic view illustrating the step of profiling the body constituted by the three mutually fixed elements of FIG. 12;

FIG. 14 is a schematic axonometric view of the fourth embodiment of the manufactured article, according to the invention;

FIG. 15 is a schematic view illustrating the step of profiling a blank constituted by a plurality of mutually fixed elements in order to obtain a plurality of manufactured articles according to the invention in a fifth embodiment;

FIG. 16 is a schematic axonometric view of a manufactured article according to the invention in its fifth embodiment.

### DESCRIPTION OF THE PREFERRED EMBODIMENTS

With particular reference to the figures, the reference numeral 1 generally designates a manufactured article made of ceramic, natural or artificial stone, for finishing buildings, claddings, furnishings or the like.

The manufactured article 1 is constituted by two or more flat elements, such as strips 2 made of ceramic, natural or artificial stone, which are mutually assembled and rigidly coupled into a monolithic body 3 by fixing means 4 arranged at least proximate to the region where they join.

The body 3 has a profiled front surface A, which is suitable to form the variously shaped exposed surface of the manufactured article 1, and a rear surface B, which is suitable to form the surface for coupling the manufactured article 1 to portions or surfaces of buildings, claddings, furnishings or the like to be finished.

The strips 2 can be obtained by cutting one or more tiles 5 or slabs, and each strip has a front face 6, which corresponds to the exposed surface V of the tile 5, and a rear face 7, which corresponds to the laying surface P of the tile 5, where the so-called “back pattern” is provided.

The strips 2 are assembled so that the surface S of one strip and the surface S of the other strip that are in mutual contact are not the respective rear faces 7; the rear face 7 of any strip 2 that constitutes a manufactured article 1 is never in contact with any face and/or surface and/or side of the other strips 2 that constitute the manufactured article 1.

Two consecutive strips 2 of the manufactured article 1 can be assembled so as to be mutually incident at an angle that can be preset, so that the respective front face 6 of one strip is in contact with a side 8 of the other strip; in this case, the surfaces S that are in mutual contact are indeed constituted by the front face 6 of one of the two strips 2 and by the side 8 of the other strip 2, while the respective rear faces 2 are clear.

In particular, two consecutive strips 2 can be arranged so as to be incident at 90° in order to form a substantially L-shaped profile.

As an alternative, the mutually contacting surfaces S of two consecutive strips 2 can have a respective bevel on a plane having a preset inclination, so that the strips 2 can be mutually assembled so that they are mutually incident at an angle other than 90°.

Two consecutive strips 2 of a manufactured article 1 can also be assembled so that they are mutually superimposed and substantially parallel and staggered, so that their respective front faces 6 face each other and are partially in contact; in this case, the mutually contacting surfaces S of the two strips 2 are constituted by portions of their front faces 6, while the rear faces 7 are clear and are directed in opposite directions.

The manufactured article 1 can be composed by assembling two or more strips 2 and/or two or more preassembled modules constituted by two or more strips 2.

The fixing means 4 are constituted by binding material 9, such as adhesives, glues or the like, arranged proximate to the region where the assembled strips 2 join, and in; particular in the portion of volume and/or in an interspace 10 delimited thereby.

Advantageously, the strips 2 can have recesses 11 for containing the fixing means 4, which are formed proximate to the region where they join and/or proximate to their surfaces S that are suitable to be arranged in mutual contact; the recesses 11 are open at the rear surface B of the body 3.

Conveniently, the rear surface B of the body 3 has end edges 12 that are beveled for blending with the portions or surfaces of buildings, claddings, furnishings or the like to be finished.

The manufactured article 1 further comprises means 13 for anchoring to the portions or surfaces of buildings, claddings, furnishings or the like to be finished, which are formed at the rear surface B of the body 3.

The anchoring means 13 can be constituted for example by interlocking means, of the male or female type, such as threaded inserts 14 that are at least partially immersed in the binding material 9 and are suitable to couple to complementary interlocking means, respectively of the female or male type, such as screws, which are rigidly coupled to the portions or surfaces of the buildings, claddings, furnishings or the like to be finished, or to plates for coupling to said portions or surfaces; the inserts 14 are supported by a support 15, which is embedded in the binding material 9.

The front surface A of the body 3 is contoured by profiling so as to be shaped like a torus, cove, molding, or the like.

The manufactured article 1 can be used as a border, capital, skirting, coving, element for connecting protruding parts, for finishing edges or corners, decoration or the like in the field of buildings, furnishings and cladding of walls and floors in general.

The method for producing a manufactured article 1 comprises a step for cutting the strips 2 from tiles 5, made for example of stoneware, vitrified stoneware, marble, granite or the like; the cutting step consists in cutting the tile 5 along predefined lines 16 with the aid of conventional cutting means, such as cutters, grinders or the like, which are not shown since they are of a conventionally known type.

The method according to the invention further comprises a step for assembling two or more strips 2, which are arranged so that the surfaces S that are in mutual contact are not the respective rear faces 7 (which correspond to the laying surface P of the tile 5), a step for fixing the strips 2 thus assembled into a monolithic body 3, and a step for profiling the body 3 in order to obtain a manufactured article 1 in which the exposed front surface A is contoured and the rear surface B is suitable to constitute the surface for coupling the manufactured article 1 to portions or surfaces of buildings, claddings, furnishings or the like to be finished.

The assembly step consists in joining two or more strips 2, arranging them in pairs so as to be mutually incident along an angle that can be predefined, the respective front face 6 (which corresponds to the exposed surface V of the tile 5) of one of said strips being in contact with a side 8 of the other strip, or in pairs which are mutually superimposed and substantially parallel and staggered, with their respective front faces 6 in mutual contact.

Two consecutive strips 2 can be arranged so as to be mutually incident at an angle of 90° in order to form a substantially L-shaped profile.

If two consecutive strips 2 are to be assembled so that they are incident at an angle other than 90°, the method according to the invention comprises a preliminary step, not shown, for beveling, along planes having a predefined inclination, the surfaces S of the two strips 2 that must be placed in mutual contact.

Advantageously, the strips 2 are joined with the aid of jigs 17 or open molds, in which the strips 2 in mutual contact are arranged and assembled; removable metal shims 18 can be inserted between the bottom or walls of the jig 17 and the strips 2.

The fixing step consists in arranging the binding material 9 in the portion of the volume and/or of the interspace 10 that is delimited by the strips 2 assembled at least proximate to the region where they join; this occurs, for example, by pouring the binding material 9 into the jig 17, inside which the strips 2 are arranged so as to be mutually assembled.

The method according to the invention can also comprise a step for cutting into the strips 2 proximate to their surfaces S that are suitable to be arranged in mutual contact, in order to obtain thereat recesses 11 that are open at the rear surface B of the body 3, for the containment of the binding material 9; in this last case, the fixing step consists in filling the recesses 11 with the binding material 9.

Conveniently, the method according to the invention comprises a step of inserting the anchoring means 13 (threaded inserts 14) in the binding material 9 before it sets completely; the inserts 14 are meant to couple to screws that are monolithically coupled for example to a plate for grip on a surface to be clad, said plate being interposed between the surface to be clad and the tiles of the cladding.

In this case, the binding material 9 is not introduced so as to fill the interspace 10 completely, but a step 19 for supporting the cladding tiles is created with the aid of the shims 18.

The strips 2, mutually assembled and fixed by the binding material 9, form a monolithic body 3, which is subjected to the profiling step, which consists in milling and/or grinding and/or polishing the front surface A of the body 3, removing from it material 20 so as to give it a chosen profile 21; the front surface A is thus contoured.

Finally, the method can comprise a step for beveling the edges 12 of the rear surface B of the body 3, so that they can be blended with the portion or surface to be finished and/or with their cladding.

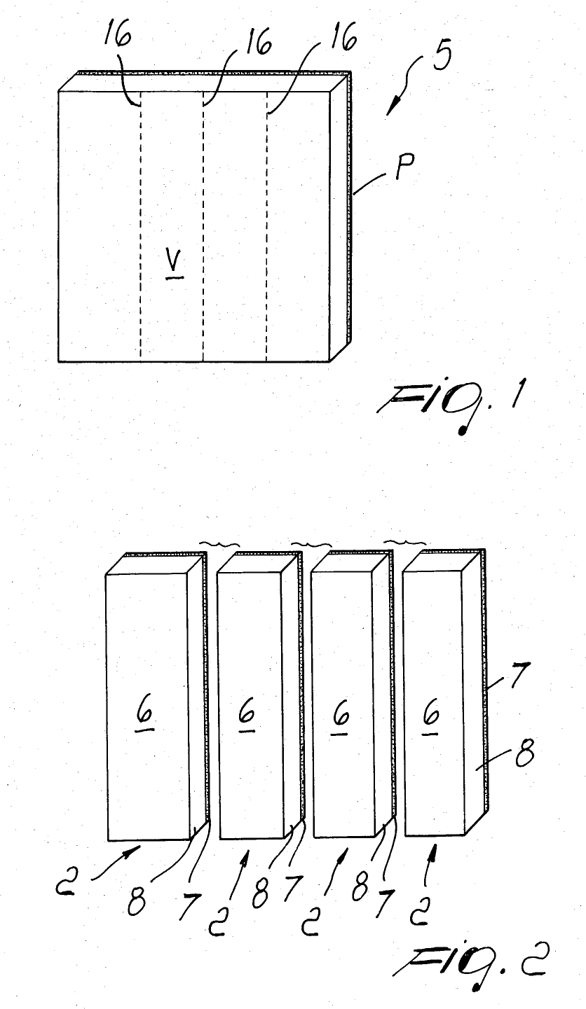

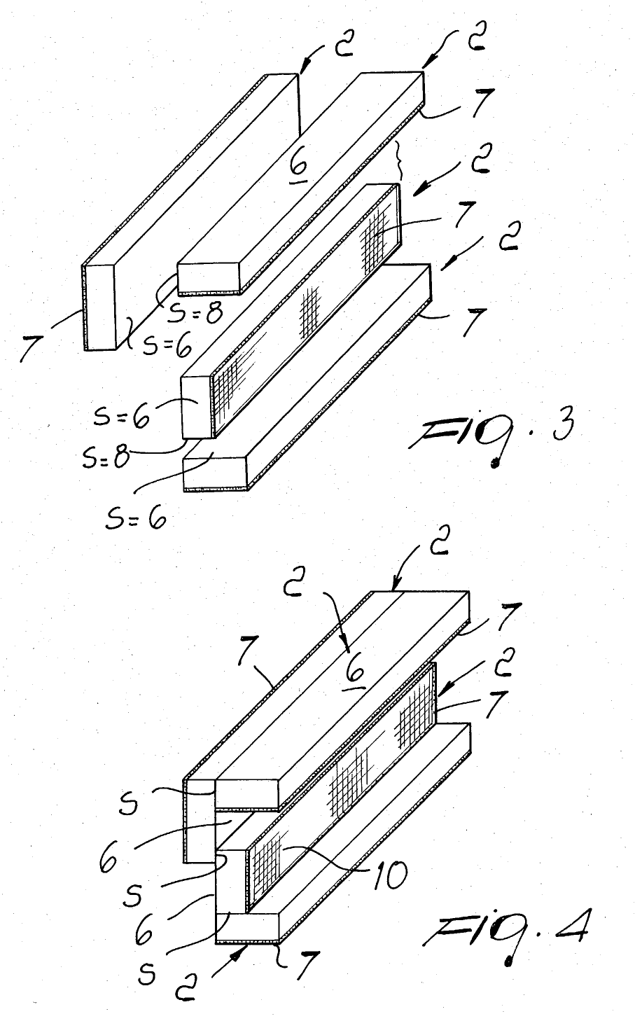

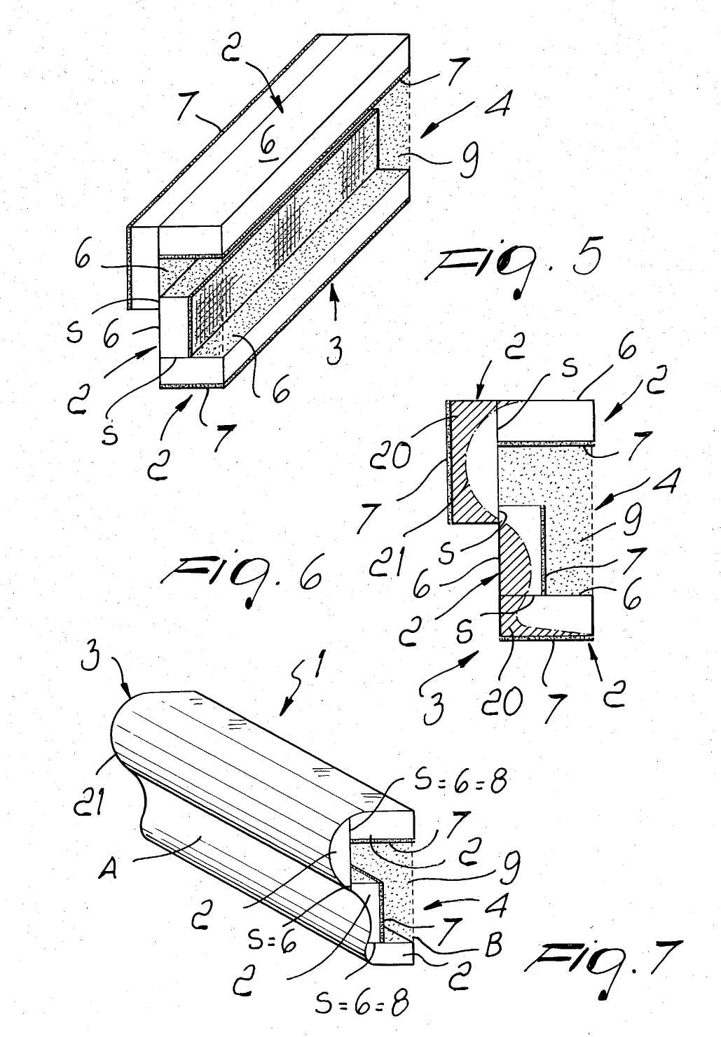

FIGS. 1 to 7 illustrate the steps of the production of a manufactured article 1 according to the invention, constituted by four consecutive strips 2, which can be used as a torus for finishing claddings, as a capital, molding or the like.

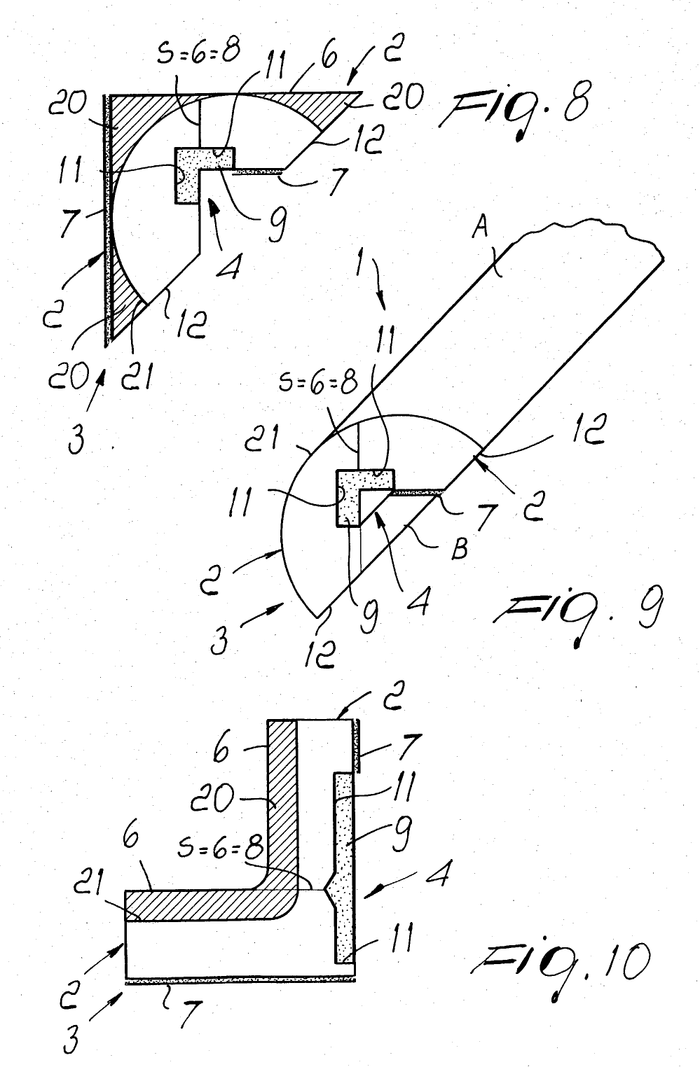

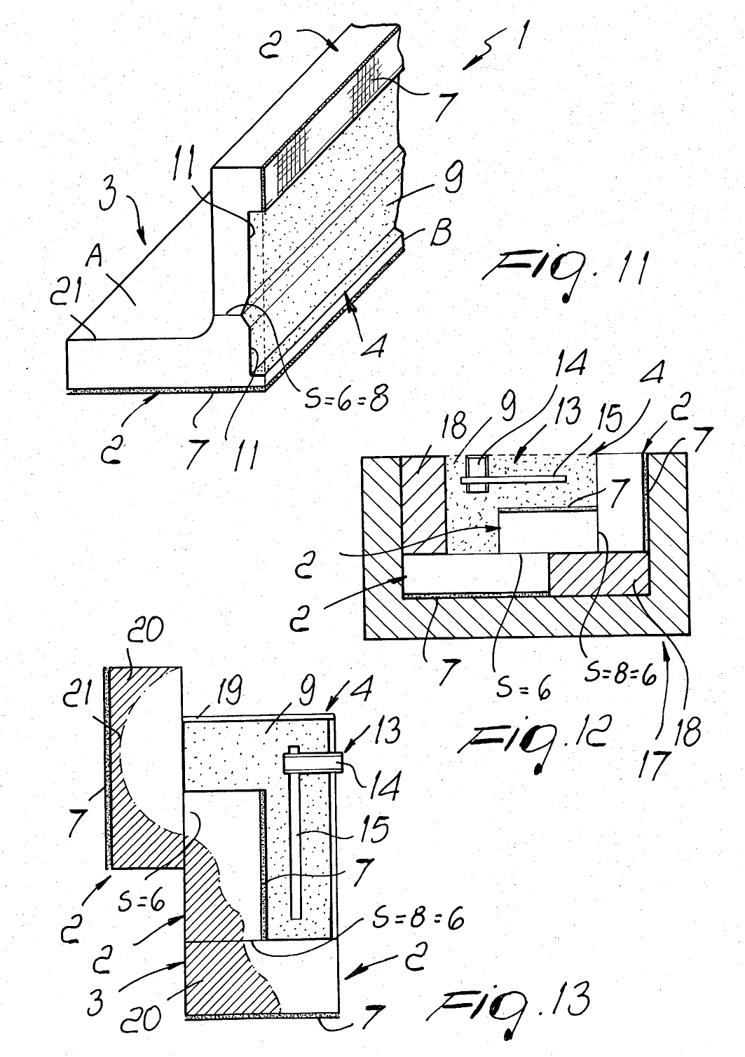

FIGS. 8-9 and 10-11 illustrate two manufactured articles 1 according to the invention, both constituted by two consecutive strips 2, which can be used respectively as a finishing element for protruding edges or corners formed by two surfaces that are incident at 90°.

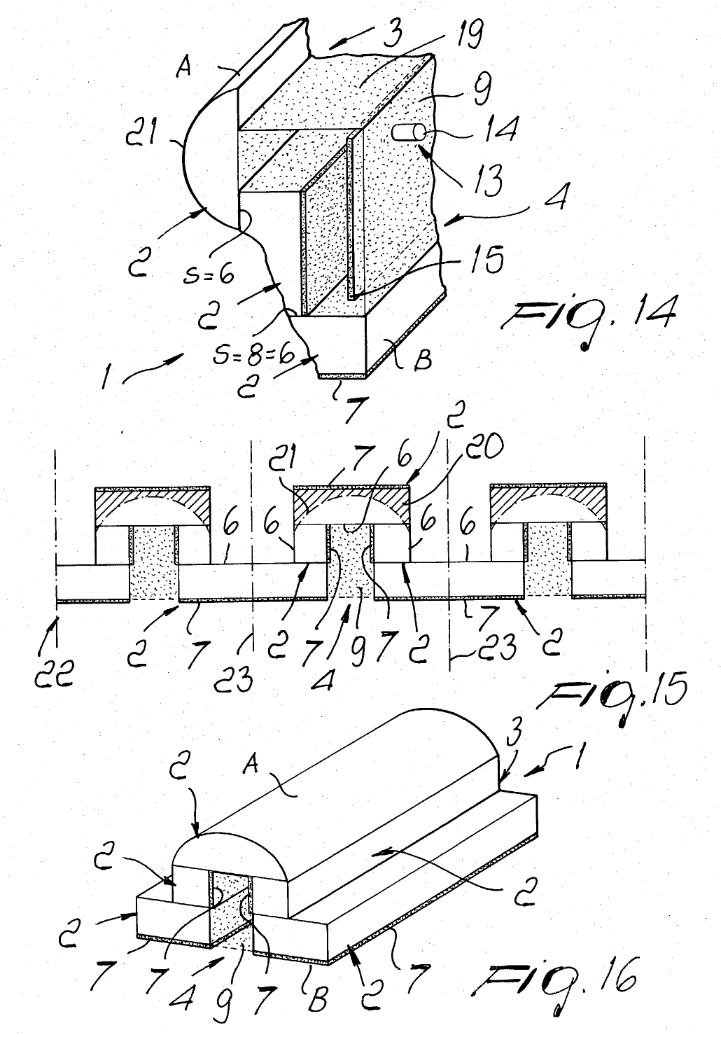

FIGS. 12 to 14 illustrate the steps of the production of a manufactured article 1 according to the invention, which is constituted by three consecutive strips 2 and can be used as a finishing element for protruding is edges and as a blending element between two perpendicular surfaces.

Finally, FIG. 15 illustrates a blank 22, which can be obtained with the method according to the invention and is constituted by a plurality of strips 2 which are mutually assembled and fixed in a portal-like configuration that is periodically repeated; by cutting the manufactured article 22 along the cutting lines 23, one obtains a plurality of manufactured articles 1 of the type known in the field as pencil tiles, which can be used as a decorative insert in claddings.

It is noted that the manufactured article 1 can be constituted by strips 2 that are made of the same material as the cladding to be finished, thus allowing to provide consistent and uniform finishes; it requires no additional operations for polishing the surfaces S that are meant to be arranged in mutual contact and allows to eliminate level differences in coupling.

The manufactured article 1 is of the modular monolithic type, does not require the use of pigmented adhesives, and can be profiled and contoured variously, being suitable to countless disparate applications.

In practice it has been found that the described invention achieves the intended aim and objects.

The invention thus conceived is susceptible of numerous modifications and variations, all of which are within the scope of the appended claims.

All the details may further be replaced with other technically equivalent elements.

In practice, the materials used, as well as the shapes and the dimensions, may be any according to requirements without thereby abandoning the scope of the protection of the appended claims.

The disclosures in Italian Patent Application No. MO2002A000040 from which this application claims priority are incorporated herein by reference.

What is claimed is:

1. A manufactured article made of ceramic, natural or artificial stone, for finishing buildings, claddings, or furnishings, comprising: at least two substantially flat elements including contact and laying surfaces thereof and made of ceramic, natural or artificial stone, said flat elements being mutually assembled at the contact surfaces which are different from the respective laying surfaces, so as to form a monolithic body; fixing means for coupling said flat elements that are arranged at least proximate to a region where said flat elements are joined, said body having a profiled front surface, that forms an exposed surface of the manufactured article, and a rear surface that forms a coupling surface for coupling said manufactured article to portions and surfaces of buildings, claddings or furnishings to be finished.

2. The manufactured article of claim 1, wherein said flat elements are constituted by strips.

3. The manufactured article of claim 1, wherein said flat elements are assembled so as to be mutually incident at an angle that is presetable, with a respective exposed surface of one of said flat elements being in contact with a side of the other flat element.

4. The manufactured article of claim 3, wherein said angle is substantially 90°, said flat elements forming a substantially L-shaped profile.

5. The manufactured article of claim 3, wherein the contact surfaces of said two elements arranged in mutual contact are beveled according to inclined planes that are predefined, said flat elements being arranged so as to be mutually incident at an angle other than 90°.

6. The manufactured article of claim 1, wherein said flat elements are assembled so as to be mutually superimposed and substantially parallel and staggered, with respective exposed surfaces thereof partially in mutual contact.

7. The manufactured article of claim 1, wherein said fixing means comprises binding materials selected from a group including adhesives, glues and other suitable bonding materials.

8. The manufactured article of claim 7, wherein said fixing means are arranged at least in a portion of volume delimited by said two assembled flat elements proximate to a joining region thereof.

9. The manufactured article of claim 8, wherein said flat elements comprise recesses, which are formed proximate to said joining region, said recesses accommodating said fixing means.

10. The manufactured article of claim 9, wherein said recesses are open at said rear surface of said body.

11. The manufactured article of claim 1, wherein said rear surface of said body has beveled edges for blending with said portions or surfaces of buildings, claddings, or furnishings to be finished.

12. The manufactured article of claim 11, wherein said front surface of said body is profiled with a shape of a torus, cove, or molding.

13. The manufactured article of claim 7, further comprising anchoring means for anchoring to said portions or surfaces of buildings, claddings, or furnishings to be finished, said anchoring means being formed at the rear surface of said body.

14. The manufactured article of claim 13, wherein said anchoring means comprises: interlocking means, of the male or female type, said interlocking means being at least partially inserted in the binding material; and complementary interlocking means, respectively, of the female or male type, said interlocking means at least partially inserted in the binding material mating with said complementary interlocking means that are rigidly coupled to any of said portions, surfaces of buildings, claddings, furnishings to be finished, and to plates for gripping said portions or surfaces.

15. A method for forming a manufactured article made of ceramic, natural or artificial stone for finishing buildings, claddings, or furnishings, comprising: a step for assembling at least two substantially flat elements having contact and laying surfaces and being made of ceramic, natural or artificial stone, which are arranged so that the contact surfaces thereof that are in mutual contact are different from the respective laying surfaces; a step for fixing the flat elements thus assembled in a monolithic body; and a step for profiling said body in order to obtain a manufactured article with a contoured exposed surface.

16. The method of claim 15, further comprising a step for cutting said flat elements from tiles or slabs made of ceramic, natural or artificial stone, said flat elements being shaped like strips.

17. The method of claim 16, wherein said cutting step consists in cutting said tiles or slabs into said strips.

18. The method of claim 15, wherein said assembly step consists in joining two flat elements arranged so as to be mutually incident at an angle that is predefined, with a respective exposed surface of one of said flat elements being in contact with a side of the other flat element.

19. The method of claim 18, wherein said angle is substantially 90°, said flat elements forming a substantially L-shaped profile.

20. The method of claim 18, comprising a step for beveling, along inclined planes that are predefined, the contact surfaces of said two flat elements that are arranged in mutual contact, said flat elements being arranged so as to be mutually incident at an angle other than 90°.

21. The method of claim 15, wherein said assembly step consists in joining two flat elements so that they are mutually superimposed and substantially parallel and staggered, with respective exposed surfaces thereof mutually partially in contact.

22. The method of claim 21, wherein said joining consists in placing said flat elements in mutual contact in an open-top jig, and inserting removable shims between bottom or walls of said jig and said flat elements.

23. The method of claim 22, wherein said fixing step consists in arranging fixing means at least in a portion of a volume that is delimited by two assembled flat elements, proximate to a region where the flat elements join.

24. The method of claim 23, wherein said fixing means comprises binding materials, from a group comprising adhesives, glues and other suitable bonding materials.

25. The method of claim 24, comprising a step for cutting recesses into said flat elements proximate to the contact surfaces thereof, said recesses accommodating said fixing means.

26. The method of claim 25, wherein said fixing step consists in pouring said binding material into said jig inside which said flat elements are assembled.

27. The method of claim 26, wherein said fixing step consists in filling said recesses with said binding material.

28. The method of claim 24, comprising a step for inserting in said binding material, before it sets, anchoring means for anchoring to portions or surfaces of buildings, claddings or furnishings to be finished.

29. The method of claim 28, wherein said anchoring means comprises interlocking means, of the male or female type, which mate with complementary interlocking means, respectively, of the female or male type, that are rigidly coupled to any of said portions or surfaces of buildings, claddings, or furnishings to be finished, and to plates for gripping said portions or surfaces.

30. The method of claim 15, wherein said profiling step consists in any of milling, grinding and polishing the front surface of said monolithic body.

31. The method of claim 30, comprising a step of beveling edges of a rear surface of said body.
